(19) United States
(12) Patent Application Publication
(10) Pub. No.: US 2014/0159670 A1
(43) Pub. Date: Jun. 12, 2014

(54) POWER CONTROL APPARATUS FOR VEHICLE BATTERY

(71) Applicants: Kia Motors Corporation, Seoul (KR); Hyundai Motor Company, Seoul (KR)

(72) Inventors: Young Jong Lee, Seoul (KR); Jun Seo Park, Hwaseong (KR)

(73) Assignees: Kia Motors Corporation, Seoul (KR); Hyundai Motor Company, Seoul (KR)

(21) Appl. No.: 13/921,533

(22) Filed: Jun. 19, 2013

(30) Foreign Application Priority Data
Dec. 10, 2012 (KR) 10-2012-0142664

(51) Int. Cl. B60L 11/18

(52) U.S. Cl. CPC B60L 11/1851
USPC 320/134; 320/128

(57) ABSTRACT

A power control apparatus for a vehicle battery that includes a relay configured to interrupt or connect electric power supplied from the battery to a vehicle; current sensors configured to detect a battery discharging current supplied to a load of the vehicle through the relay, and a battery charging current introduced from an alternator of the vehicle. In addition, the apparatus includes a controller configured to output a control signal to execute an on/off drive of the relay based on detection values of the current sensors to control the electric power supplied from the battery to the vehicle. The relay, the current sensors, and the controller are mounted to the battery, and the current sensor includes a high current sensor having a substantially large current measurement range and a low current sensor having a substantially small current measurement range.

### CROSS-REFERENCE TO RELATED APPLICATION

This application claims under 35 U.S.C. §119(a) the benefit of Korean Patent Application No. 10-2012-0142664 filed Dec. 10, 2012, the entire contents of which are incorporated herein by reference.

### BACKGROUND

(a) Technical Field

The present invention relates to a power control apparatus for a vehicle battery, and more particularly to a power control apparatus for a vehicle battery which can automatically interrupt power of the battery during an overcurrent, a collision of the vehicle, discharging of the battery due to a dark current, or overcharging of the battery.

(b) Background Art

As generally known in the art, a battery that supplies electric power to a start motor during a start-up of a vehicle or supplies electric power to various electric loads such as an audio visual (AV) system, lamps, sensors, and a controller is mounted to the vehicle.

Such batteries may include a 24 V battery according to a model of the vehicle in addition to a 12 V battery, and as the number of electric loads in a vehicle has increased recently, a 42 V battery is being applied. Such a vehicle battery is configured to supply electric power to a start motor or electric loads in the vehicle through discharging of currents and is configured to store electric power for an alternator through charging of currents when the alternator is driven during a travel of the vehicle.

In addition, an ignition switch box which is a main element for that supplies/interrupts battery power to and from an electric load is disposed within the vehicle, and a driver manipulates an ignition switch with a start key to determine supply of electric power. Then, the ignition switch functions as a switch that supplies battery power to an electric load in the vehicle, and some electric loads are circuited to directly receive electric power from the battery without using an ignition switch to be turned on and off.

Moreover, an overcurrent may be generated in a battery during a collision or an overturn of the vehicle, aging of the vehicle, or a malfunction of a load, which overcurrent may cause a fire due to emission of heat. In particular, when electric power is continuously supplied from a battery to an electric load during an accident such as a collision of the vehicle, a short circuit and a secondary fire may be generated, when the power of the battery is unconditionally interrupted, electric power that unlocks a door may not be supplied, which may cause a safety risk of a passenger.

Further, when a start motor of the vehicle is stopped (e.g., ignition switch off), for example, for parking, flow of currents supplied from a battery to an electric load may be interrupted but currents of the battery are continuously supplied for an instantaneous start-up or to units such as a controller.

When unnecessary currents such as a dark current are continuously consumed or a state of charge (SOC) of the battery is not efficiently managed, a load may not be used and a start-up of the engine may not be enabled due to discharging of currents, resulting in a decrease of a life span of the battery or fuel ratio of the vehicle.

### SUMMARY

The present invention provides a power control apparatus for a vehicle which may automatically interrupt power of the battery during an overcurrent or a collision of the vehicle to prevent a fire of the vehicle and protect electric parts.

The present invention also provides a power control apparatus for a vehicle which may automatically interrupt electric power when the battery is discharged at a predetermined level or higher when the vehicle is parked to secure start-up performance of the vehicle and prevent a decrease of the life span of the battery due to complete discharging of the battery.

The present invention further provides a power control apparatus for a vehicle which measures a battery charging state to prevent the battery from being overcharged via control of power generation of an alternator when the battery is charged at a predetermined level or higher, thus improving fuel efficiency of the vehicle and enhancing life span of the battery.

The present invention also provides a power control apparatus for a vehicle which integrates functions, such as interruption of power of the battery, control of charging and discharging, and interruption of a dark current, which has been performed by separate apparatuses, reducing manufacturing costs, reducing weight, and improving reliability.

In accordance with an aspect of the present invention, a power control apparatus for a vehicular battery, may include: a relay configured to interrupt or connect electric power supplied from the battery to a vehicle; current sensors configured to detect a battery discharging current supplied to a load of the vehicle through the relay, and a battery charging current introduced from an alternator of the vehicle; and a controller configured to output a control signal to operate an on/off drive of the relay based on detection values of the current sensors to control the electric power supplied from the battery to the vehicle, wherein the relay, the current sensors, and the controller are mounted to the battery, and the current sensor may include a high current sensor having a substantially large current measurement range and a low current sensor having a substantially small current measurement range.

In an embodiment of the present invention, the high current sensor and the low current sensor may be installed at a front end or a rear end of the relay in a circuit connected to a positive terminal of the battery, a load connection terminal, and an alternator/starter connection terminal

In another embodiment of the present invention, the controller may be configured to receive an on/off state of an ignition switch, and may be configured to compare a detection value of the high current sensor with a reference value in an ignition switch on state, and when an overcurrent state in which the detection value is the reference value or greater, off-control the relay to interrupt the electric power of the battery.

In still another embodiment of the present invention, when receiving information of a speed sensor from the vehicle and determining that the vehicle is stopped, the controller may be configured to execute a door unlock of the vehicle before the electric power of the battery is interrupted. In addition, when receiving a collision detection signal and an airbag operation signal from the vehicle, the controller may be configured to off-control the relay to interrupt the electric power of the battery. Furthermore, after receiving a collision detection signal and an airbag operation signal and before interrupting the electric power of the battery, the controller may be configured to output a signal to execute a door unlock of the vehicle.

In a still further embodiment of the present invention, the controller may be configured to receive an on/off state of an ignition switch, and when determining that a dark current of a predetermined level or higher is generated from a detection value of the low current sensor in an ignition switch off state, may be configured to off-control the relay to interrupt the electric power of the battery.

Moreover, after calculating a SOC of the battery, the controller may be configured to determine that a dark current of a predetermined level or greater is generated when a detection value of the low current sensor exceeds a set current. In addition, the controller may be configured to receive an on/off state of an ignition switch, and after calculating a SOC change obtained by integrating charging/discharging currents during a travel of the vehicle using a detection value of the high current sensor in an ignition switch on state, may be configured to add the SOC change to a SOC before the travel of the vehicle to calculate a current SOC and output the current calculated SOC to use the current SOC in control of power generation of an alternator in a controller of the vehicle.

Accordingly, the present invention may automatically interrupt power of the battery when an overcurrent or a collision of the vehicle occurs to prevent a fire of the vehicle and protect electric parts. Further, the present invention may automatically interrupt electric power when the battery is discharged at a predetermined level or greater while the vehicle is parked to secure start-up performance of the vehicle and prevent a decrease of the life span of the battery due to complete discharging of the battery. Furthermore, the present invention may measure a battery charging state to prevent the battery from being overcharged via control of power generation of an alternator when the battery is charged at a predetermined level or greater, thus improving fuel efficiency of the vehicle and enhancing life span of the battery. In addition, the present invention may integrate functions, such as interruption of power of the battery, control of charging and discharging, and interruption of a dark current, which has been performed by separate apparatuses, thus reducing manufacturing costs, reducing weight, and improving reliability.

### BRIEF DESCRIPTION OF THE DRAWINGS

The above and other features of the present invention will now be described in detail with reference to exemplary embodiments thereof illustrated the accompanying drawings which are given hereinbelow by way of illustration only, and thus are not limitative of the present invention, and wherein:

FIG. 1 is an exemplary circuit diagram of a power control apparatus for a battery according to an exemplary embodiment of the present invention;

FIG. 2 is an exemplary circuit diagram of a power control apparatus for a battery according to another exemplary embodiment of the present invention;

FIG. 3 is an exemplary view showing connections of the power control apparatus according to an exemplary embodiment of the present invention;

FIG. 4 is an exemplary view schematically showing a power connection of the power control apparatus according to an exemplary embodiment of the present invention and a vehicle;

FIG. 5 is an exemplary view of the battery to which the power control apparatus according to an exemplary embodiment of the present invention is mounted;

FIG. 6 is an exemplary plan view exemplifying a state in which constituent elements of the power control apparatus according to an exemplary embodiment of the present invention are disposed in the battery;

FIG. 7 is an exemplary flowchart showing a control process when an overcurrent is generated according to an exemplary embodiment of the present invention;

FIG. 8 is an exemplary flowchart showing a control process when a collision of the vehicle occurs according to an exemplary embodiment of the present invention;

FIG. 9 is an exemplary flowchart showing a process of controlling interruption of electric power due to a dark current when the vehicle is parked according to an exemplary embodiment of the present invention;

FIG. 10 is an exemplary battery charging/discharging diagram during a travel of the vehicle according to an exemplary embodiment of the present invention; and

FIG. 11 is an exemplary flowchart showing a power generation control process through a SOC according to an exemplary embodiment of the present invention.

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles, fuel cell vehicles, and other alternative fuel vehicles (e.g. fuels derived from resources other than petroleum).

Additionally, it is understood that the term controller refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, exemplary embodiments of the present invention will be described in detail with reference to the accompanying drawings so that those skilled in the art to which the invention pertains can easily carry out the invention.

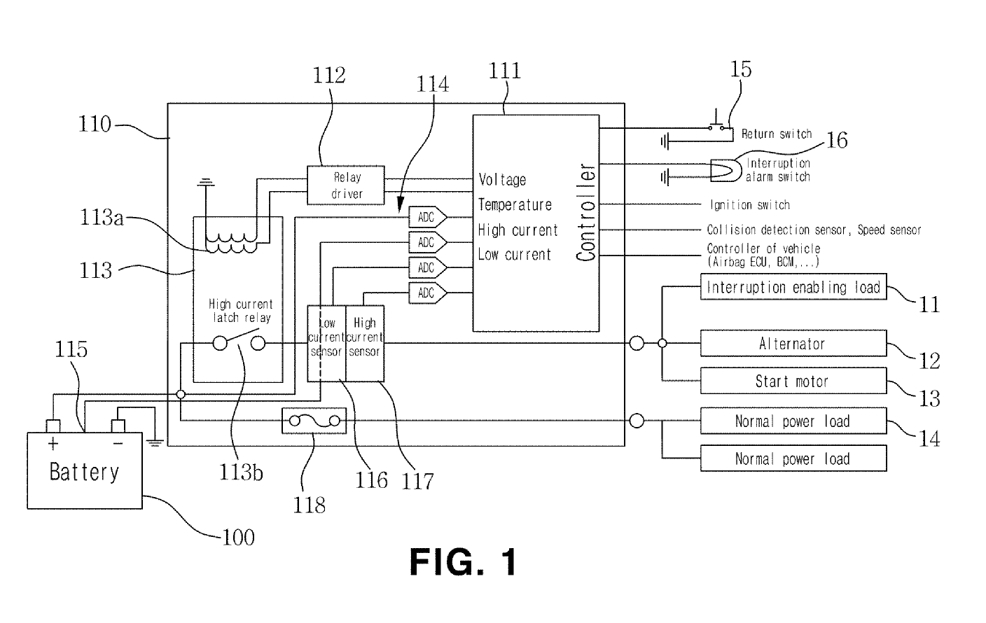

FIG. 1 is an exemplary circuit diagram of a power control apparatus for a battery according to an exemplary embodiment of the present invention. A controller 111, a relay driver 112, a relay 113, a voltage sensor 113, a temperature sensor 115, a high current sensor 116, a low current sensor 117, and a fuse 118 of the power control apparatus for a battery of the present invention, which will be described below and may be mounted to the battery 100 (but separately shown in the drawing), a circuit of the power control apparatus 110 for a battery will be described below with reference to FIG. 1.

As shown in FIG. 1, the circuit may include a controller 111 configured to output a control signal to selectively interrupt and connect electric power supplied from the battery 100, and a relay 113 driven on or off based on the control signal output by the controller 111 to interrupt or connect electric power supplied from the battery 100 to the vehicle.

The relay 113 may be a relay operated to be driven based on a control signal of the controller 11, and may be realized by a high current latch relay capable of interrupting a high current. The drive of the relay 113 may be controlled by the relay driver 112 that selectively applies or interrupts a current to an energizing coil 113a of the relay based on a control signal of the controller 111.

The electric power of the battery 100 may be supplied to a load 11 and a start motor 13 of the vehicle via a relay contact 113b while the relay 113 is turned on, and the electric power of the alternator 12 may be supplied to the battery 100 via the relay contact 113b. Accordingly, when the controller 111 executes an on/off drive of the relay 113, the electric power supplied from the battery 100 to the load 11 and the start motor 13 may be interrupted or connected (e.g., a discharging control), and the electric power of the alternator 12 may be selectively supplied to the battery 100 to charge the battery 100.

Further, the controller 111 of the power control apparatus 100 for a battery according to an exemplary embodiment of the present invention may be configured to collect battery state information such as a voltage and a temperature of the battery 100, a charging/discharging current, a state of charge (SOC), and may be configured to provide the collected battery state information (an SOC etc.) to another controller of the vehicle to use the battery state information for an operation of the vehicle.

The battery 100 may include a voltage sensor 113 configured to measure a voltage of the battery, a temperature sensor 115 configured to measure a temperature of the battery, and current sensors 116 and 117 configured to measure charging/discharging currents to allow the controller 111 to collect the battery state information, and the measured information may be input to the controller 111. Among them, the current sensors configured to measure charging/discharging currents may be classified into two current sensors having different measurement ranges, that is, a high current sensor 116 and a low current sensor 117, and the high current sensor 116 may be a current sensor having a substantially large measurement range to measure a high current.

Moreover, the low current sensor 117 may be a current sensor having a substantially small measurement range, and may be configured to measure a current which is low as compared with the high current sensor 116, that is, a substantially small amount of currents within a predetermined range. The high current sensor 116 and the low current sensor 117 may be installed on a circuit that supplies electric power from the battery 100 to the load 11 of the vehicle, that is, a determined load of the vehicle whose electric power from the battery 100 may be interrupted when necessary via a contact 113b of the relay 113.

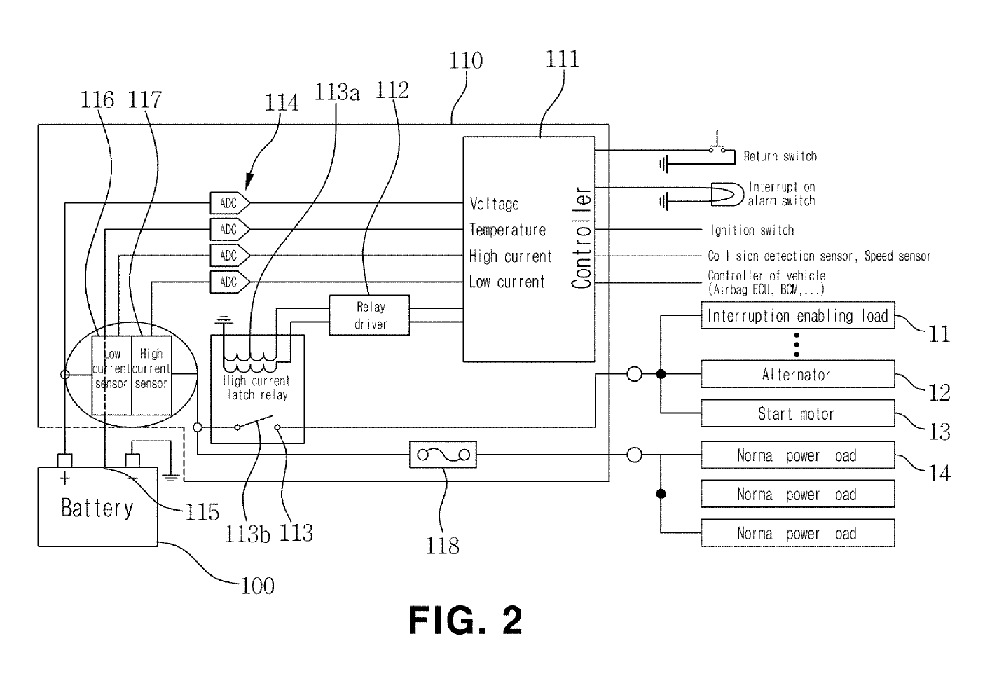

The high current sensor 116 and the low current sensor 117 may be installed at a rear end of the relay 113 which is a power interrupting unit of the battery 100 as exemplified in FIG. 1, but may be installed at a front end of the relay 113 as exemplified in FIG. 2.

FIG. 1 is an exemplary circuit diagram of a power control apparatus for a battery according to an exemplary embodiment of the present invention. Further, the controller 111 may be connected to an ignition switch to allow a power state of the vehicle to be recognized, that is, an on/off state of the ignition switch may be input, and may be connected to a return switch 15 manipulated to allow the electric power from the battery 100 to be interrupted and returned into a power supply state.

When the return switch 15 is manipulated, the controller 111 having received a switch manipulation switch may be configured to turn on the relay 113 to supply the electric power of the battery 100. The controller 111 may be connected to a power interruption alarm lamp 116 of the vehicle to inform of an interruption of the battery power, and may turn on the power interruption alarm lamp 116 when the relay 113 is turned off to interrupt supply of the power of the battery 100.

Reference numeral 118 in FIGS. 1 and 2 denotes a fuse installed on a circuit to which the power load 14 may be connected and short-circuited to interrupt an overcurrent. Further, according to the present invention, the controller 111 may be configured to receive signals of a speed sensor and a collision detection sensor of the vehicle, and may be connected to other controllers (e.g., an air bag engine control unit (ECU), a body control module, etc.) to transmit and receive information through a control area network (CAN) communication (e.g., connected to the other controllers through a CAN communication module (not shown)).

For example, the controller 111 may be configured to transmit battery state information, battery power interruption information, and the like to the controller 111 of the vehicle through a CAN communication, and may be configured to receive door state information (e.g., lock/unlock information) from a body control module (BCM) and output a signal to operate a door unlock to transmit the signal to the BCM when necessary.

Further, the controller 111 may be configured to receive airbag operation information, that is, a signal indicating an airbag expansion operation from the airbag ECU. Accordingly, the controller 111 may be configured to determine an overcurrent, a dark current, a collision of the vehicle, and the like to control supply of electric power, and may be configured to predict a battery state to perform a charging/discharging control.

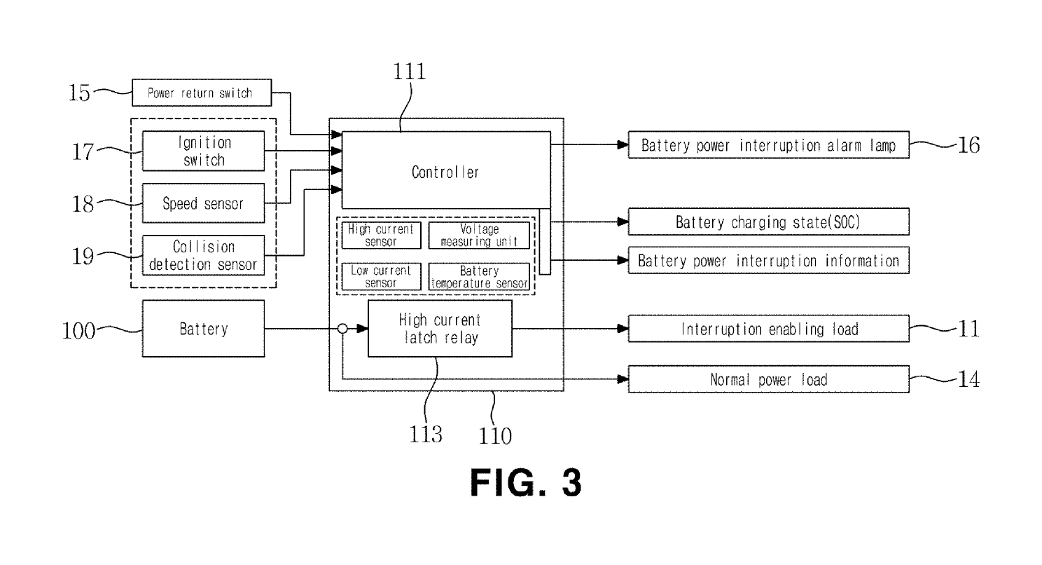

The configuration of the power control apparatus for a battery according to the exemplary embodiment present invention has been described so far, and FIG. 3 is an exemplary view briefly showing the connection between the power control apparatus 110 for a battery according to an exemplary embodiment of present invention and the elements of the vehicle which coincide with the above-described contents, and shows input elements and output elements connected to the controller 111 of the power control apparatus 110 for a battery.

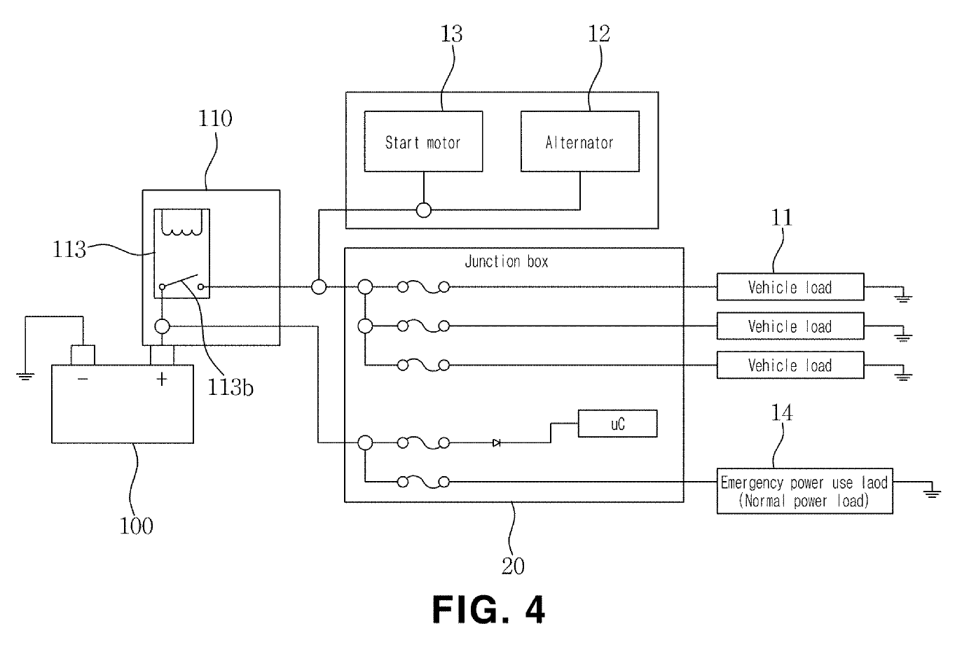

FIG. 4 is an exemplary view schematically showing a power connection of the power control apparatus according to an exemplary embodiment of the present invention and the vehicle, and shows the relay 113 to selectively interrupt and connect electric power supplied from the battery 100, the start motor 13 and the alternator 12 connected to the contact 113b of the relay 113, and connections of the loads 11 and 14 of the vehicle to the contact 113b of the relay 113 through a junction box 20 of the vehicle.

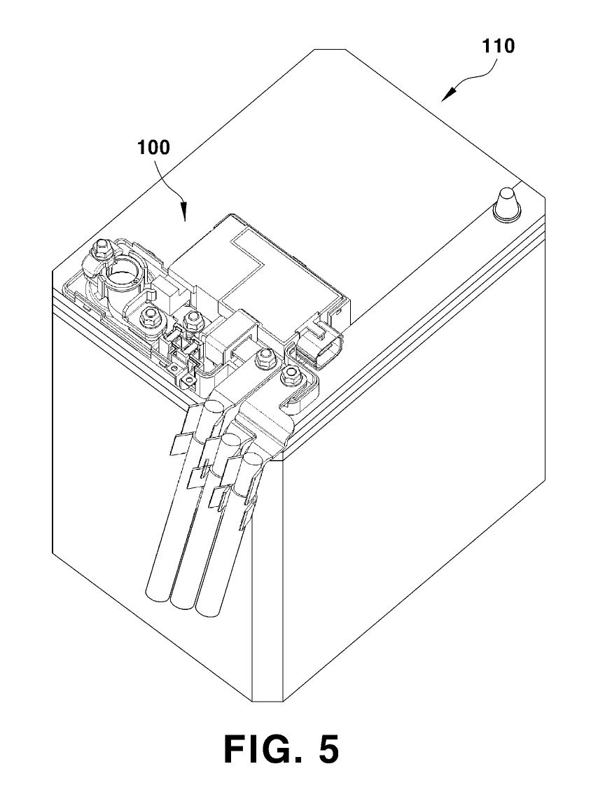

FIG. 5 is an exemplary view of the battery to which the power control apparatus according to an exemplary embodiment of the present invention may be mounted, and the constituent elements of the power control apparatus 110 for a battery according to an exemplary embodiment of the present invention may be mounted to the battery 100.

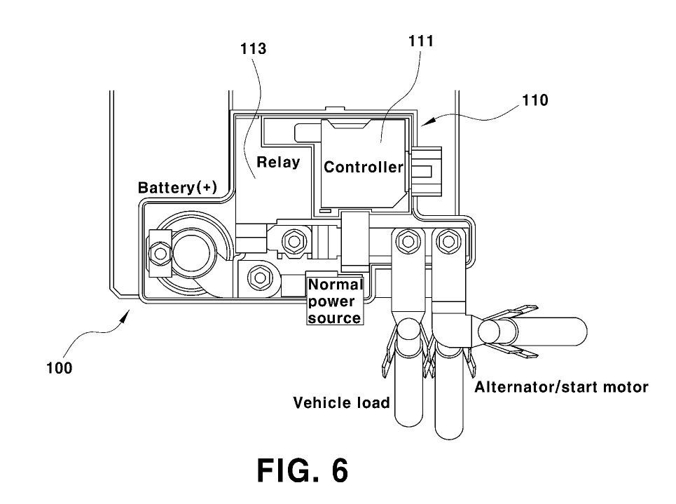

FIG. 6 is an exemplary plan view exemplifying a state in which constituent elements of the power control apparatus 110 according to an exemplary embodiment of the present invention may be disposed within the battery, and shows the controller 111 and the relay 113 of all the constituent elements and also shows a normal power terminal, a vehicle load terminal, and an alternator/starter terminal.

The current sensor of the power control apparatus for a vehicle according to an exemplary embodiment of the present invention is not shown in FIG. 6, but may be disposed at a front end or a rear end of the relay 113 in wiring between a positive terminal of the battery 100 and a load connection terminal, and an alternator/starter connection terminal as shown in FIG. 1.

Hereinafter, a power control process performed by the power control apparatus for a battery having the above configuration will be described.

First, when an overcurrent is generated due to aging of the vehicle, a malfunction of a load, or a collision of the vehicle, an alarm may be generated through the power interruption alarm lamp while the battery power supplied to the load is interrupted, and thus a fire generated due to emission of heat may be prevented.

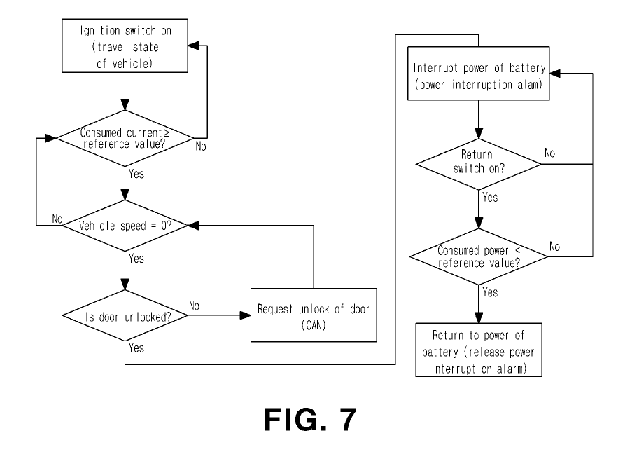

FIG. 7 is an exemplary flowchart showing a control process when an overcurrent is generated according to an exemplary embodiment of the present invention, detection information of the high current sensor 116 may be used in an ignition switch on state in which the vehicle travels, and the electric power of the battery 100 may be interrupted when an overcurrent by which the detection value (e.g., consumed currents, that is, discharged currents) exceeds a reference value while the vehicle is stopped.

That is, as shown in FIG. 7, when the consumed currents (e.g., the detection value of the high current sensor) is a preset reference value or greater in an ignition switch on state, the controller 111 may be configured to receive information of the speed sensor 18 from the vehicle and determine whether the vehicle is stopped from the information.

Next, when the vehicle is stopped, a door lock/unlock state may be identified by the B CM before the electric power of the battery 100 is interrupted, and a door unlock may be executed from the BCM to unlock the door when the door is locked.

Furthermore, the relay 113 may be off-controlled to interrupt the electric power of the battery, and the power interruption alarm lamp 16 may be turned on to alarm an interruption. Thereafter, when a turn-on operation of a return relay 15 is detected, whether the consumed currents are below the reference value may be identified, and in response to determining that the consumed currents are below the reference value, the relay 113 may be turned on to release the interruption of the electric power (e.g., return to the electric power of the battery) and turn off the power interruption alarm lamp 16 to release the alarm state.

In particular, when the consumed currents are continuously the reference value or greater, the relay 113 may be configured to maintain the power interruption and alarm state while maintaining an off state regardless of a turn-on operation of the return switch 15.

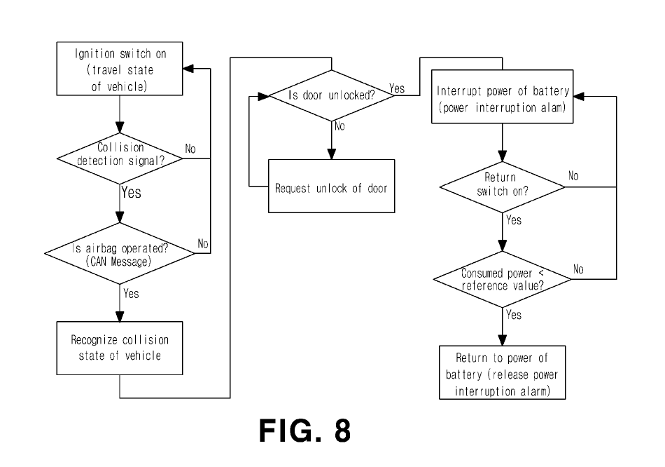

FIG. 8 is an exemplary flowchart showing a control process during a collision of the vehicle, and when the controller 111 determines that a collision of the vehicle is generated from the collision detection signal of the collision detection sensor 19, the airbag controller may be configured to identify an operation of an airbag.

Then, when an airbag operation signal is input by the airbag controller, a vehicle collision state may be determined and a door lock/unlock state may be identified from the BCM. In the case of a door lock state, a door unlock may be executed by the BCM to unlock the door. Subsequently, the relay 113 may be off-controlled to interrupt the electric power of the battery, and the power interruption alarm lamp 16 may be turned on to alarm that the electric power is interrupted.

Thereafter, when a turn-on operation of the return switch 15 is detected, whether the consumed currents are a reference value or lower may be identified, and in response to determining that the consumed currents are a reference value or lower, the relay 113 may be turned on to release the interruption of the electric power (e.g., return to the power of the battery) and turn off the power interruption alarm lamp 16 to release the alarm state. In particular, when the consumed currents are continuously the reference value or greater, the interruption of the power and the alarm state may be maintained while the off state of the relay 113 is continuously maintained regardless of a turn-on operation of the return switch 15.

Moreover, the consumed currents may be measured via the low current sensor 117 to measure the low current supplied to the load in an ignition switch off state such as parking of the vehicle, in which case when an excessive current is consumed (that is, in the case of an excessive dark current), the electric power of the battery may be interrupted and an alarm may be generated through the power interruption alarm lamp 16 to prevent discharging of the battery due to a dark current during an ignition switch off state.

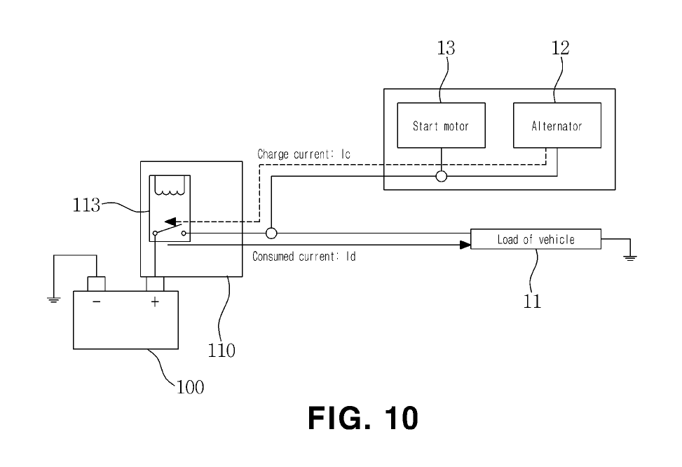

FIG. 10 is an exemplary flowchart showing a power interruption control process due to a dark current when the vehicle is parked, and when determined that a dark current of a predetermined level or greater is generated, the controller 111 of the power control apparatus 110 mounted to the battery 100 may be configured to perform a control process of interrupting the battery power in an ignition switch off state such as parking of the vehicle using detection information of the low current sensor 117.

First, the controller 111 may be configured to receive a voltage and a temperature of the battery measured via the voltage sensor 113 and the temperature sensor 115 in an ignition switch off state (e.g., a parking state of the vehicle), receive a consumed current measured via the low current sensor 117, and calculate an SOC to an open circuit voltage (OCV) based on the voltage and the temperature (e.g., a temperature of a battery liquid may be predicted to be used after a peripheral temperature of the battery is input from the sensor).

In particular, when the SOC is less than a preset value A and the consumed current exceeds the set current B, the controller 111 may be configured to off-control the relay 113 to interrupt the electric power of the battery and turn on the power interruption alarm lamp 16 to alarm the interruption of the electric power. Then, the set value may be set to a necessary SOC value during cold cranking, and the set current may be a reference current value to determine generation of an excessive dark current.

Thereafter, when a turn-on operation of the return switch 15 is detected, the relay 113 may be turned on to release the interruption of the power (e.g., return to the power of the battery) and turn off the power interruption alarm lamp 16 to release the alarm state.

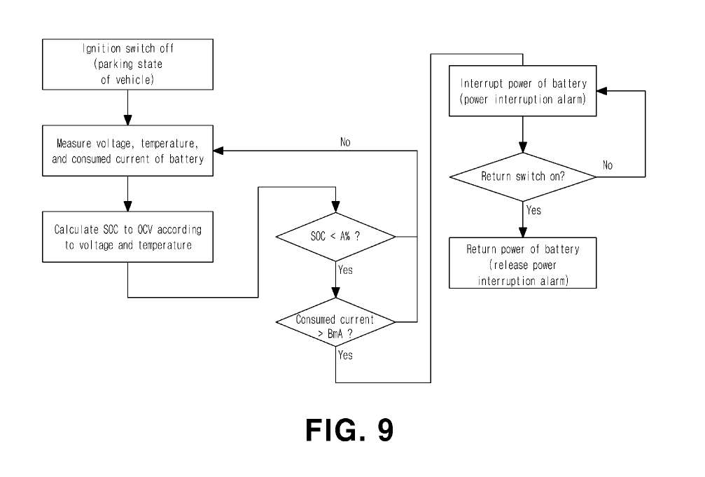

Next, FIG. 9 is a battery charging/discharging diagram during a travel of the vehicle, and shows that electric power and charging currents (Ic) may be supplied to the battery 100 due to driving of the alternator during charging and also shows a consumed current (e.g., discharged current) Id flowing from the battery 100 to a load of the vehicle during discharging.

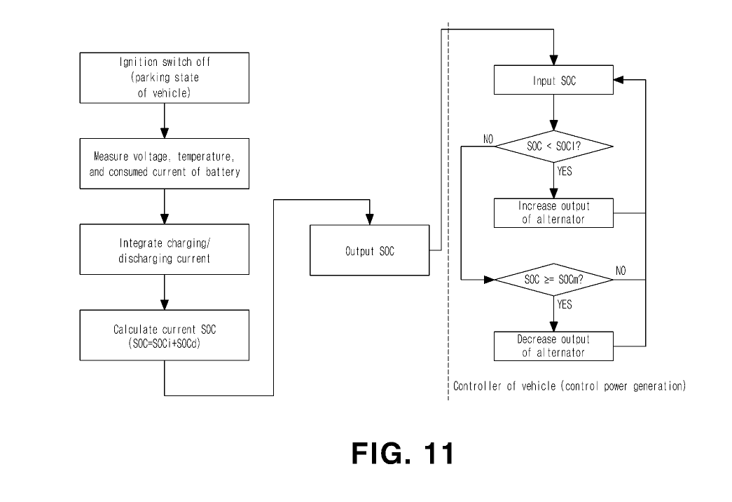

FIG. 11 is an exemplary flowchart showing a power generation control process through an SOC, and the controller 111 of the power control apparatus for a battery may be configured to measure a charging/discharging current (e.g., detected through a high current sensor) during a travel of the vehicle, calculate a state of charge (SOC) of the battery, and provide information necessary to operate power generation to the controller of the vehicle.

The controller of the vehicle may be configured to prevent the battery from being overcharged by the electric power introduced into the battery 100 from the alternator 12 via control of power generation, thus improving efficiency of the battery.

First, the controller 111 of the power control apparatus 110 mounted to the battery 100 in an ignition switch on state (e.g., a travel state of the vehicle) may be configured to receive a voltage and a temperature measured via the voltage sensor 113 and the temperature sensor 115, receive a current measured via the high current sensor 116, and integrate charging/discharging currents.

Then, a current SOC may be calculated by adding a charging/discharging current integration, that is, a SOC change (e.g., SOCd=ΣIc+ΣId) calculated by integrated the charging/discharging currents during a travel of the vehicle to an SOC (SOCi) before the travel of the vehicle calculated from the voltage and temperature of the battery at a time point when the ignition switch is turned on, and the current SOC may be output to be transferred to the controller 111 of the vehicle.

Furthermore, the controller 111 of the vehicle may be configured to compare the current SOC transferred from the controller 111 of the battery 100 with a preset battery discharging limit value (SOCI), and when the current SOC is less than the limit value, may be configured to execute power generation to increase an output of the alternator.

Moreover, when the current SOC is the limit value or greater and the present battery charging limit value SOCm, control of power generation for decreasing an output of the alternator may be performed. Accordingly, the power control apparatus for a battery of the present invention may be configured to integrate a current sensor used for measurement of an SOC, a current sensor system, and a battery power interruption system to have an SOC calculation function instead of a simply current measurement function, thereby reducing a processed load of the controller of the vehicle.

The invention has been described in detail with reference to exemplary embodiments thereof. However, it will be appreciated by those skilled in the art that changes may be made in these exemplary embodiments without departing from the principles and spirit of the invention, the scope of which is defined in the accompanying claims and their equivalents.

What is claimed is:

1. A power control apparatus for a vehicular battery, comprising:
a relay configured to interrupt or connect electric power supplied from the battery to a vehicle;
current sensors configured to detect a battery discharging current supplied to a load of the vehicle via the relay, and a battery charging current introduced from an alternator of the vehicle; and
a controller configured to output a control signal to operate an on/off drive of the relay based on detection values of the current sensors to operate the electric power supplied from the battery to the vehicle,
wherein the relay, the current sensors, and the controller are mounted to the battery, and the current sensor includes a high current sensor having a substantially large current measurement range and a low current sensor having a substantially small current measurement range.

2. The power control apparatus of claim 1, wherein the high current sensor and the low current sensor are installed at a front end or a rear end of the relay in a circuit connected to a positive terminal of the battery, a load connection terminal, and an alternator/starter connection terminal.

3. The power control apparatus of claim 1, wherein the controller is configured to:
receive an on/off state of an ignition switch;
compare a detection value of the high current sensor with a reference value in an ignition switch on state; and
off-control the relay to interrupt the electric power of the battery during an overcurrent state when the detection value is the reference value or greater.

4. The power control apparatus of claim 3, wherein when receiving information of a speed sensor from the vehicle and determining that the vehicle is stopped, the controller is configured to execute a door unlock of the vehicle before the electric power of the battery is interrupted.

5. The power control apparatus of claim 1, wherein when receiving a collision detection signal and an airbag operation signal from the vehicle, the controller is configured to off-control the relay to interrupt the electric power of the battery.

6. The power control apparatus of claim 5, wherein after receiving a collision detection signal and an airbag operation signal and before interrupting the electric power of the battery, the controller is configured to output a signal to execute a door unlock of the vehicle.

7. The power control apparatus of claim 1, wherein the controller is configured to:
receive an on/off state of an ignition switch; and
off-control the relay to interrupt the electric power of the battery in response to determining that a dark current of a predetermined level or greater is generated from a detection value of the low current sensor in an ignition switch off state.

8. The power control apparatus of claim 7, wherein after calculating a state of charge of the battery, the control unit is configured to determine that a dark current of a predetermined level or greater is generated when a detection value of the low current sensor exceeds a set current.

9. The power control apparatus of claim 1, wherein the controller is configured to:
receive an on/off state of an ignition switch;
integrate charging/discharging current during a travel of the vehicle using a detection value of the high current sensor in an ignition switch on state; and
add the state of charge change to a state of charge before the travel of the vehicle to calculate a current state of charge and output the current calculated state of charge to use the current state of charge to execute power generation of an alternator in a controller of the vehicle.

10. The power control apparatus of claim 1, wherein the power control apparatus may be applied to vehicles including hybrid vehicles, fuel cell vehicles, and electric vehicles.

11. A non-transitory computer readable medium containing program instructions executed by a processor or controller, the computer readable medium comprising:
program instructions that control a relay to interrupt or connect electric power supplied from the battery to a vehicle;
program instructions that control current sensors to detect a battery discharging current supplied to a load of the vehicle via the relay, and a battery charging current introduced from an alternator of the vehicle; and
program instructions that output a control signal to operate an on/off drive of the relay based on detection values of the current sensors to operate the electric power supplied from the battery to the vehicle,
wherein the relay, the current sensors, and the controller are mounted to the battery, and the current sensor includes a high current sensor having a substantially large current measurement range and a low current sensor having a substantially small current measurement range.

12. The non-transitory computer readable medium of claim 11, wherein the high current sensor and the low current sensor are installed at a front end or a rear end of the relay in a circuit connected to a positive terminal of the battery, a load connection terminal, and an alternator/starter connection terminal.

13. The non-transitory computer readable medium of claim 11, further comprising:
program instructions that receive an on/off state of an ignition switch;
program instructions that compare a detection value of the high current sensor with a reference value in an ignition switch on state; and
program instructions that off-control the relay to interrupt the electric power of the battery during an overcurrent state when the detection value is the reference value or greater.

14. The non-transitory computer readable medium of claim 13, further comprising:
program instructions that execute a door unlock of the vehicle before the electric power of the battery is interrupted when receiving information of a speed sensor from the vehicle and determining that the vehicle is stopped.

15. The non-transitory computer readable medium of claim 11, further comprising:
program instructions that off-control the relay to interrupt the electric power of the battery when receiving a collision detection signal and an airbag operation signal from the vehicle.

16. The non-transitory computer readable medium of claim 15, further comprising:
program instructions that output a signal to execute a door unlock of the vehicle after receiving a collision detection signal and an airbag operation signal and before interrupting the electric power of the battery.

17. The non-transitory computer readable medium of claim 11, further comprising:
program instructions that receive an on/off state of an ignition switch; and
program instructions that off-control the relay to interrupt the electric power of the battery in response to determining that a dark current of a predetermined level or greater is generated from a detection value of the low current sensor in an ignition switch off state.

18. The non-transitory computer readable medium of claim 17, further comprising:
program instructions that determine that a dark current of a predetermined level or greater is generated when a detection value of the low current sensor exceeds a set current after calculating a state of charge of the battery.

19. The non-transitory computer readable medium of claim 11, further comprising:
program instructions that receive an on/off state of an ignition switch;
program instructions that integrate charging/discharging current during a travel of the vehicle using a detection value of the high current sensor in an ignition switch on state; and
program instructions that add the state of charge change to a state of charge before the travel of the vehicle to calculate a current state of charge and output the current calculated state of charge to use the current state of charge to execute power generation of an alternator in a controller of the vehicle.
